(19) United States
(12) Patent Application Publication
(10) Pub. No.: US 2016/0371951 A1
(43) Pub. Date: Dec. 22, 2016

(54) LOW POWER SYSTEM AND DEVICE FOR DETECTING UV RADIATION

(71) Applicant: Visionware Solutions Pty Ltd, Chatswood (AU)

(72) Inventor: Ran Asher PELEG, Chatswood (AU)

(21) Appl. No.: 15/182,130

(22) Filed: Jun. 14, 2016

(30) Foreign Application Priority Data
Jun. 17, 2015 (AU) 2015902314
May 19, 2016 (AU) 2016901874

(51) Int. Cl. G08B 21/18; H04W 4/02; H04W 4/00; H04L 29/08

(52) U.S. Cl. CPC G08B 21/18; H04L 67/10; H04W 4/02; H04W 4/008; H04W 84/18

(57) ABSTRACT

A system and device for detecting and/or monitoring solar or UV radiation. More particularly, provided is a portable low power system and device for detecting ultraviolet (UV) radiation which is adapted to communicate with a server.

### CROSS-REFERENCE TO RELATED APPLICATIONS

Australian Patent Application No. 2015902314, filed on Jun. 17, 2015, and Australian Patent Application No. 2016901874, filed on May 19, 2016, are incorporated herein by reference in their entirety.

### TECHNICAL FIELD

The present disclosure relates to a system and device for detecting and/or monitoring solar or UV radiation. More particularly, the present disclosure may relate to a portable low power system and device for detecting ultraviolet (UV) radiation which is adapted to communicate with a server.

### BACKGROUND

The number of skin cancer and other sun related aliments have been increasing over the last several decades. With increasing populations the incidence of skin cancer cases will only increase without preventative measures. High levels of UV radiation exposure may cause an increased possibility for a person to develop UV related medical issue, such as skin cancer.

The Fitzpatrick scale was developed as a numerical classification schema for human skin colour as a way to classify the typical response of skin to ultraviolet (UV) light. This scale may be used to determine weather conditions are safe for a person to have a prolonged exposure to the sun or other UV light sources.

Some known devices use an array of fixed or permanent UV detectors over a predetermined area which detect UV radiation over a gridded area. However, these devices cannot predict an individual's personal exposure of UV radiation and require a significant amount of energy to operate. These devices generally have a fixed number of sensors and may only collect information from a predetermined location. Therefore, these devices or systems may have a significant number of data collection blackspots or gaps, which may result in an incorrect data set. Previous systems have been large or bulky.

While some portable devices for detecting radiation are known, these devices are generally cumbersome, expensive and are not discretely used. These devices are not generally suitable to be carried by a user comfortably or discretely and therefore users are less inclined to use such a device. Further, these devices also require a significant amount of power to function and require constant recharging or frequent replacement of batteries to effectively operate.

Further, these devices usually require a large number of features such as an inbuilt screen, GPS or positioning hardware, buttons and other features which may drastically increase the manufacturing costs and are generally not intended to be disposable.

As such, there may be a need for a low power energy usage or high energy efficiency and low cost device which may log or record UV radiation exposure.

Any discussion of the prior art throughout the specification should in no way be considered as an admission that such prior art is widely known or forms part of common general knowledge in the field.

### SUMMARY

### Problems to be Solved

The present disclosure may relate to an energy efficient UV radiation detection device.

The present disclosure may relate to a compact and portable device for monitoring UV exposure.

The present disclosure may relate to a cost effective system for monitoring UV exposure levels.

The present device may relate to a monitoring system which may reduce the risk of UV radiation related adverse conditions, such as skin cancer.

The present disclosure may relate to a system or device for reducing UV radiation exposure.

The present disclosure may relate to a system or device for generating a UV radiation map.

It is an object of the present disclosure to overcome or ameliorate at least one of the disadvantages of the prior art, or to provide a useful alternative.

### Means for Solving the Problem

A first aspect of the present disclosure may relate to a system adapted for detecting and recoding UV radiation, the system may comprise; a first device including a first shell encapsulating a power source, a micro-controller, a storage medium, at least one UV sensor and a low power wireless module. The at least one UV sensor may be adapted to detect and store UV data. The low power wireless protocol may be adapted to communicate with at least one second device. The second device may include a second shell which is adapted to receive at least a portion of the stored UV data.

The at least one UV sensor may be adapted to detect UVA and UVB radiation. The first device may further comprise an accelerometer. The first shell may further comprise an antenna. The first shell may be disposable. The first shell may comprise an attachment means such that a user may releasably attach the first shell to an item of clothing. The second shell may be adapted to upload at least a portion of the received UV data to a server in which the server may be cloud. The second shell may comprise a GPS. The second shell may be adapted to upload at least one relative location from the GPS of the first shell to the server. The second shell may be adapted to associate at least a portion of the received UV data with the relative location. At least one of the first shell and the second shell may have a water tight seal. At least one of the first shell and the second shell may be configured to issue at least one alert. The UV data may be stored by the first shell an may be deleted after the second shell receives the UV data. The UV radiation data may be selectively sampled by the first device. The first device may further comprise a status indicator. The power source may be a non-rechargeable battery.

Another aspect of the present disclosure may relate to a system adapted for detecting and recoding UV radiation. The system may comprise; a first device including a first shell comprising a power source, a micro-controller, a storage medium, at least one UV sensor and a low power module. The at least one UV sensor may be adapted to detect and store UV radiation data and the low power protocol may be adapted to communicate with a second device. The second device may comprise a second shell which may be adapted to receive at least a portion of the stored UV data. The first device may be disposable. The second device may be configured to log at least one location and associated location time and the first device may associate at least one of the stored UV radiation data with an associated UV radiation data time, such that the associated location time and the associated UV radiation data time may be associatively matched.

In the context of the present disclosure, the words “comprise”, “comprising” and the like are to be construed in their inclusive, as opposed to their exclusive, sense, that is in the sense of “including, but not limited to”.

The disclosure is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present disclosure.

### BRIEF DESCRIPTION OF THE FIGURES

FIG. 1 illustrates an embodiment of a block diagram of the first device of the system of the present disclosure;

FIG. 2 illustrates an embodiment of a process for generating UV radiation level data for use with the system of the present disclosure;

FIG. 3 illustrates a perspective of an embodiment of the first device of the present disclosure;

FIG. 4 illustrates a perspective view of another embodiment of the first device of the present disclosure with an attachment means.

### DETAILED DESCRIPTION

Preferred embodiments of the present disclosure will now be described with reference to the accompanying drawings and non-limiting examples.

In a first embodiment of the present disclosure, there may be provided a device or system 100 adapted to detect and store ultraviolet (UV) radiation data. The UV data may be at least one of UV irradiance or UV spectral irradiance. The data collected may be manipulated, factored or augmented to display a predicted UV exposure level or a UV risk level to a user or any other predetermined data set. For example, if a person has skin type-I they may have a UV factor of 0.9, while a person with skin type-II may have a UV factor of 0.75. It will be appreciated that any predetermined factors may be used to provide a UV exposure level, UV risk or UV index. Throughout this specification, the term “UV radiation” may refer to a UV radiation irradiance and/or UV spectral irradiance. While the system of the present disclosure is preferably adapted to use the Fitzpatrick scale for skin classification, it will be appreciated that a custom scale may also be used.

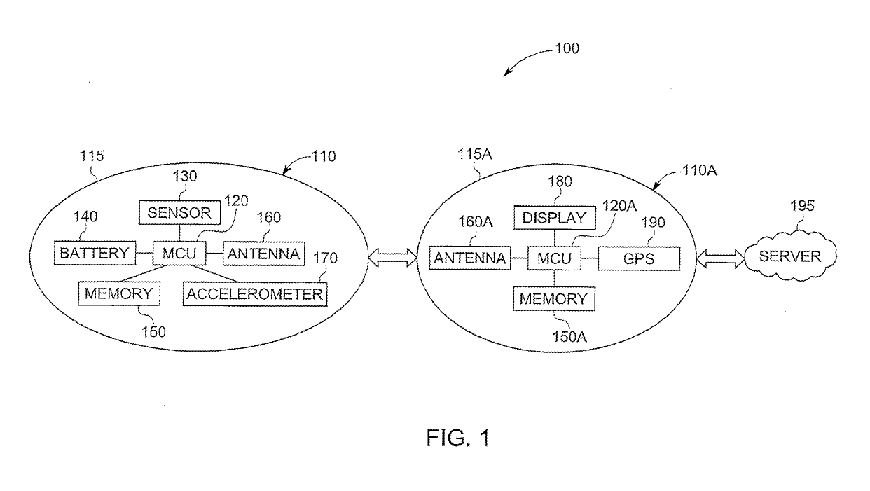

Referring to the embodiment illustrated in FIG. 1, the system 100 comprises a first device 110 and a second device 110A in which the second device 110A may optionally be in communication with a server 195. The first device 110 being configured to detect UV radiation and convert the UV radiation into UV radiation data. The data may correspond to a predetermined threshold, intensity or UV radiation irradiance level. The first device 110 and second device 110A may then be configured to synchronise with each other such that the UV radiation data may then be communicated or transmitted from the first device 110 to the second device 110A. After the second device 110A receives the UV radiation data, the second device 110A may associate the UV radiation data with a user account and upload the data to a server 195. The server 195 may then assess, analyse or augment the data such that the data may be used to generate at least one data set, such as a heat map, a radiation map, UV exposure data or any other data associated with the stored UV radiation. At least a portion of the generated data set may be displayed on a display device, for example, a display of the second device or an internet browser.

In at least one embodiment, the first device 110 is adapted to detect and store radiation data, preferably UV radiation data. The first device 110 may be adapted to detect at least one of UVA, UVB and UVC radiation. More preferably, the first device 110 detects both of UVA and UVB radiation. It will be appreciated that the first device 110 may also be adapted to detect other forms of radiation. As illustrated in the Figures, the first device 110 comprises a first shell 115 which encapsulates or houses a micro-controller unit (MCU) 120, at least one radiation sensor 130, a power source 140, storage medium 150, and an antenna 160. The MCU 120 may be used to convert the received UV radiation into UV radiation data and store the UV radiation data in a storage medium 150. The MCU 120 may further be configured such that it may receive data, commands or protocols from the second device 110A.

The storage medium 150 may be for example, a flash memory, EEPROM or any other non-volatile storage medium. Preferably, the storage capacity of the first device 110 is between 128 KB to 1 MB and more preferably is about 256 KB. However, it will be appreciated that the internal memory of the first device 110 may be any predetermined size sufficient to record data.

Optionally, the first device 110 further comprises an accelerometer 170. The accelerometer 170 may be used to activate or deactivate at least one sensor 130 if there is no movement for a predetermined period of time. The accelerometer 170 may be configured to detect whether the first device 110 is falling and temporarily stop recording data if a fall is detected. The accelerometer 170 may correlate movement data with UV radiation data to determine optimal UV radiation for activities or sports. Preferably, the accelerometer 170 may detect whether a person is intentionally sunbathing or exposing themselves to high levels of UV radiation.

Preferably, the first device 110 further comprises a communication module, such as a transceiver or a low power protocol (not shown), which may be adapted to send and/or receive data which has been stored in the storage medium 150. In at least one embodiment, the communication module is integral to the MCU 120. The UV radiation data may be sent to a second device 110A adapted to communicate with the first device 110 such that the second device 110A may perform at least one of a classification, interpretation, manipulation, augmentation or otherwise correlate stored data. The stored data may be associated with at least one other data set or manipulated by a predetermined algorithm or equation. The low power protocol of the first device 110 may consume a reduced amount of power in comparison with which may improve the efficiency of the device and may reduce power consumption. A low power protocol may be, for example, a Bluetooth™ Low Energy (BLE) or any other suitable low power wireless personal area network. A BLE module may be included in the first device 110 and may be formed as part of the MCU 120.

In a further embodiment, the second device 110A uploads the UV radiation data to a cloud or server 195 which may perform at least one of a classification, interpretation, manipulation, augmentation or correlation of stored UV radiation data.

The second device 110A may a portable device, such as a tablet computer, a laptop, smartphone, mobile/cellular phone or any other electronic device which is capable of determining the relative position of the second device 110A. Preferably, the second device 110A comprises a second shell 115A comprising at least one of a display 180, a GPS 190, communication module, an antenna 160A and an associated storage medium 150A, such as a flash drive, hard drive, EEPROM, solid-state drive (SSD) or any other suitable non-volatile memory. The second device is preferably adapted to have internet or wifi connectivity such that data may be uploaded to a server 195 or cloud.

In at least one embodiment, the second device 110A may display a user account of a user on the display 180. The second device 110A may be adapted to display data associated with a user account or a public account to a user for a particular time period such that a user may see potential UV radiation exposures or other predetermined or preselected data. Other preselected data may include, for example, a UV radiation map, a heat map, common exposure levels, anticipated exposure levels, times periods to avoid a particular location, suggested preventative measures for reducing UV radiation exposure, or any other predetermined data or predetermined message.

In a further embodiment, the first device 110 is configured such that after the second device 110A receives the stored data, the data stored on the first device 110 is deleted or otherwise may be overwritten. This may allow the first device 110 to continue to record UV radiation data and ensure that there is sufficient internal storage remaining to record latest UV exposure levels. Optionally, if the internal storage has been expended with data and the device has not uploaded the data, the first device 110 may selectively delete the oldest data set or may delete the lowest value data sets such that only the highest UV exposure data sets remain.

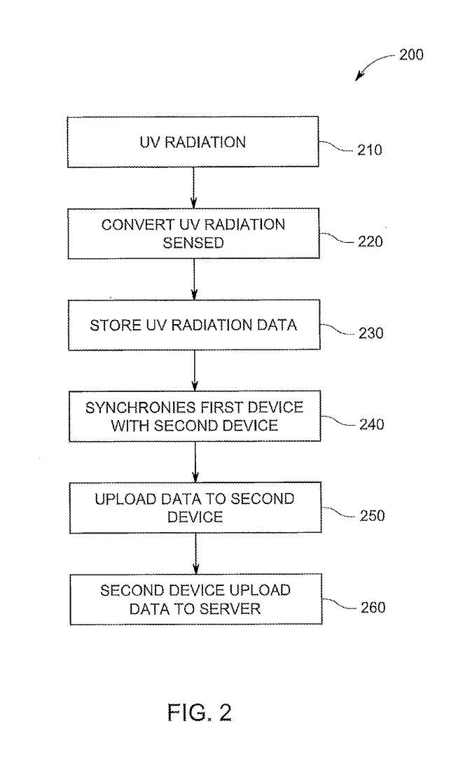

Referring to FIG. 2, there is provided an embodiment of a process flow chart 200 of the present disclosure. The first device 110 of the system 100 senses the UV radiation 210 and converts the sensed UV radiation 220 into UV radiation data. The converted UV radiation data is then stored in the memory 150 of the first device 110. Preferably, the second device 110A does not store data long term but is configured to relay at least a portion of data to a server 195 or cloud for long term storage. The user may view or extract data from the server 195 using an internet browser or application which may be associated with the second device or a third device, such as a computer or laptop. The first device 110 may be configured to communicate with the second device 110A such that the first device 110 may upload or transmit the stored UV data to the second device 110A. The second device 110A is preferably configured to upload the stored UV radiation data 250 to a server 260. Preferably, the second device 110A associates at least one coordinate location with the data and uploads the coordinate data to the server 195.

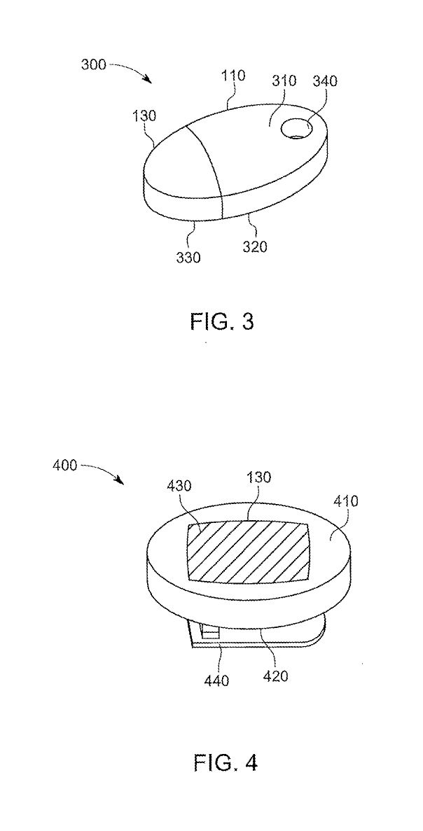

FIG. 3 depicts an embodiment of the first device 110, which comprises a first side 310 and a second side 320. The first side 310 and second side 320 of the first device 110 is illustrated with the at least one radiation sensor 130 positioned near to one end of the first device 110 such that the at least one sensor may detect radiation levels if either of the first side 310 and/or the second side 320 is facing the wearer or user. Preferably the sensor 130 is protected by, or housed in, a casing integrally formed or fluidly sealed with the first shell 115. This sensor 130 configuration may allow for a more continuous and effective recording of UV radiation data.

FIG. 4 depicts yet another embodiment of the first device 110. The first device 110 comprises a first side 410 and a second side 420, in which the first side 410 has at least one UV sensor 130 which is with a protective case 430 integrally formed with the first shell 115 and the second side 420 has a releasable securing means 440. The releasable securing means 440 may be, for example, a clip, pin, key-ring, link or other suitable fastener such that the first shell may be removably attached to an item of clothing, such as a shirt or bikini. The securing means 440 may be disposed on a side of the first shell 115, such as the top surface or the rear surface of the first shell 115. It will be appreciated that the device may be formed with a fluid resistant or fluid tight shell.

Optionally, the first device 110 comprises a status indicator (not shown) such as a light, which may indicate to a user that the device has a low battery, is synchronising or has any other predetermined status. The light is preferably an LED or other low energy consumption status indicator.

In yet another embodiment, the first device 110 preferably takes an sample or exposure reading at a predetermined or random interval and records the UV radiation reading. As such, the first device 110 may be adapted to differentially change a sampling interval for detecting UV radiation based on the time of day. For example, the predetermined interval may be every 10 (ten) seconds, or any other predetermined time. In another example, the first device 110 associates the relative time with a predetermined recording period. For example, if the time is between 6AM to 8PM, the first device 110 takes an exposure reading every 10 (ten) seconds, and between 8PM to 6AM, the first device 110 takes an exposure reading every 20 (twenty) seconds due to the likelihood of reduced radiation exposure. It will be appreciated that any predetermined or random time recording period may be configured for use by the first device 110.

In yet a further embodiment, the second device 110A may allow a user to adjust the predetermined interval between upper and lower thresholds. For example, a user may assign a 5 (five) second interval to be used during 6AM and 8PM and a 25 (twenty-five) second interval between 8PM and 6AM. In one example, the periodic increment may be several hours such that during a predetermined time period the at least one UV sensor 130 may be temporarily deactivated to reduce battery consumption. Other time periods may also be assigned by the user, or may be updated by the system 100 when the first device 110 synchronises with the second device 110A.

Preferably, the first device 110 may record and store at least 10 (ten) days of UV radiation data without synchronising with the second device 110A. More preferably, the first device 110 can store 100 (one hundred) days of data without synchronising with the second device 110A.

A first device 110 preferably comprises a unique ID or may be assigned a unique ID by the system. The unique ID may be associated with a user ID such that a user may view personal data collected. The user ID may be associated with at least one identifier stored and collates personal ID data with the server 195, such as skin type classification, a user name, a real name, working address, home address, commonly visited locations, age, sex, hair colour or any other predetermined personal information. The information associated with the user ID may be used to trigger at least one alert or message to a user, via at least one of the first device 110 or more preferably the second device 110A. An alert may be at least one of a sound, a vibration, a message, a light indicator or any other predetermined signal. For example, if a type-I skin type classification is assigned to a user ID and there is a high possibility for the user to be exposed to a significant amount of UV radiation, the system 100 may issue an alert or message to a user to stay indoors or out of direct light such that the user may limit the potential exposure to the potentially harmful UV radiation.

In at least one embodiment, the user ID and the unique ID are hashed, encrypted or otherwise anonymised such that the user ID and the unique ID cannot be accessed by a user of a system. This may improve the security of the system, such that a single user ID cannot be identified by a user of an overarching system.

The data uploaded to the server 195 by the second device 110A may be used to generate a heat map or radiation map. A heat or radiation map may be a graphical representation of the UV data on a location map, in which the location map may be an arbitrary map or a geographical map. A predetermined colour may depict a higher intensity or range of UV data values on a map. Preferably, the more solid or intense a colour on the map appears represents a relatively higher risk or higher levels of UV radiation. Alternatively the scale of relatively higher risk or higher levels of UV radiation may be colour coded with reference to a legend on the map. The heat map may have a scale for visually determining This map may be used for, for example, scientific research, predicting future radiation hot spots or used for alerting users of the system in a particular area to avoid unnecessary exposure to the radiation. This may reduce the time a user spends being exposed and therefore may reduce the potential of a UV radiation related injury or effect occurring, such as damaging skin cells which may cause skin cancer or melanomas to form.

In at least one embodiment, the first shell is preferably formed with a fluid tight seal, such as a water tight seal. This is advantageous as this may allow a user to expose or submerge the first device 110 in a liquid and still record UV exposure. This may provide a more accurate indication of the actual UV exposure of a user if worn into a body of water and may allow a user to wear the device into wet outdoor conditions.

In yet another embodiment, the first device 110 may be passively active, such that when not in use or not assigned to a user the first device 110 consumes less power than when in use. In one example, the UV sensor 130 is covered and preferably does not record radiation levels until after the cover (not shown) is removed from the sensor 130. Preferably, the cover may reflect or prohibit UV radiation from contacting the UV sensor 130, such that upon removal of the cover the UV sensor 130 the initial UV exposure activates the UV sensor 130. In another example, once a user associates a unique ID of the device with a user ID, the first device 110 may be configured to start recording UV radiation. In a further example, the first device 110 is activated only after removal a predetermined action, for example when removed from an associated packaging.

The system 100 of the present disclosure may also issue an alert to a user based on predictive location. For example, if the system 100 has at least one previous log of a user with associated location data, the system 100 may predict whether a person will be in a particular location at a particular time. Therefore, even if a user of the system 100 has not synced the first device 110 with the second device 110A, the system may issue an alert based on at least one previous log.

In yet another embodiment, the first device 110 may include a rechargeable power source or allow access to the power source 140 such that the power source may be replacable. The rechargeable battery may be inductively recharged by a user of the system, such that the first device 110 may be reused. In yet a further embodiment, the first device 110 may comprise an Apple™ security chip (not shown) or other Apple™ chip which may allow communication to Apple™ devices.

In a further embodiment, the first shell 115 of at least one of the first device 110 is textured (not shown) to improve the gripability of the device. Preferably, a predetermined logo or decal (not shown) may be disposed on the casing such that a device may be customised by a user.

Preferably, the second device 110A may log location data with associated time, otherwise referred to as a location log, and the first device 110 may store UV data with a time stamp. This may allow the system 100 to more accurately associate the logged location data and UV data relative to a user. As the second device 110A is preferably a mobile phone, such as a smart phone, the second device is likely to have been to the same locations as the user of the first device 110. As such, the user may be provided with the option to associate a location log with the UV data after the first device communicates the UV data to the second device. This may allow for an association of UV data and location data with respect to time. Optionally, the user may associate selected portions of the location log with the UV data.

In yet another embodiment, a first user first device 110 may be adapted to communicate with a second user first device 110 such that the first user first device 110 may transmit at least a portion of data to the second user first device 110. If the first user first device 110 communicates data to second user first device 110, the first user device may associate an ID or other identifier with the communicated data, such that when the second user first device 110 uploads data to the second device 110A two sets of independent data may be identified by the second device 110A.

In yet a further embodiment, the first device 110 may be adapted to communicate data to the second device 110A if the first device is a close proximity to the second device 110A. For example, if the first device is 110 within approximately 1 meter from the second device 110A. It will be appreciated that any predetermined proximity distance may also be used.

In another embodiment, the first device 110 may optionally comprise a switch (not shown), such as a button, a toggle or any other two state means. The switch may be configurable to be in an active position or an inactive position, such that when the switch is in the active position the communication module the first device 110 is active and may be adapted to communicate with the second device 110A. When the switch is in an inactive position the communication module is inactive and may reduce the overall power consumption of the first device 110.

In a further embodiment, the communication module of the first device 110 may be configurable to be in an inactive state and an activate state. Preferably, the first device 110 is in an inactive state in which the communication module is inactive. The communication module first device 110 may be configured to be in the active state by shaking or vigorously moving the first device 110. Optionally, the accelerometer may be adapted to detect shaking or movement of the device to activate the communication module. Alternatively, the first device 110 may further comprise a gyroscope or sensor (not shown) which may be adapted to detect shaking or vigorous movement of the first device 110. If the first device 110 is in communication with a second device 110A the communication module will remain active until either a user has disconnected the connection, which is preferably a wireless connection, or the connection between the first device 110 and the second device is lost 110A, for example if the first device 110 is a not within a predetermined radius of the second device 110A. If the device 110 is not in communication with a second device 110A, the communication module may turn off or return to an inactive state after a predetermined amount of time, such that power consumption of the first device 110 is reduced.

In yet a further embodiment, the first device 110 may automatically connect with any second device 110A with an appropriate application which is in close proximity to the first device. This may allow for more “real-time” or more current UV data to be uploaded to the server 195 or cloud, such that if UV radiation is detected to be relatively high or unsafe a warning may be issued to users.

In a further embodiment, the radiation sensor may be 130 adapted to detect any predetermined electromagnetic waves. Optionally, the device comprises multiple sensors to detect multiple forms of radiation, or may have more than one sensor orientated at different angles, relative to one another. Disposing sensors at different angles may assist with determining a more true reading of radiation exposure of a user.

Referring to FIG. 4, there is illustrated a further embodiment of the internal components 500 of the first device 110. The radiation sensor 130 is positioned at an angle relative to the printed circuit board (PCB) of the first device 110. In an alternative embodiment, the radiation sensor 130 is positioned at an angle relative to a source of radiation, for example the sun. Preferably, the angle of the radiation sensor 130 to either the source of radiation and/or the PCB is between 30 to 60 degrees, and more preferably between around 40 to 50 degrees, and even more preferably is around 45 degrees. It will be appreciated that the angle of the sensors may also be relative to the protective case (see FIGS. 3 and 4). Disposing the sensor at an angle which is not parallel or perpendicular to the body may assist with capturing electromagnetic radiation and therefore may be adapted to provide more accurate detection of radiation. Mounting the sensor at an angle may be of particular advantage, for example, when a device is worn on the wrist of a user. The internal components of the device preferably include a power source 140, a microprocessor (also referred to as a micro-controller unit 120) and at least one transmitter (or more preferably a transceiver).

Preferably, the radiation sensor 130 angle relative to the source of radiation is such that regardless of which position the device is orientated, the device will be adapted to detect radiation from the source of radiation. Preferably, the relative angle between the source of radiation and the radiation sensor 130 can be determined by the first device such that the calculation of radiation exposure can be factored, modified or otherwise altered to reflect a more accurate radiation exposure.

Preferably, the first device 110 is adapted to be worn on a user's wrist or on an item of clothing. The radiation sensor 130 may also be adapted to be attached to other devices, such as a mobile phone case or the like. This may allow a user to only have the device active while they are in a source of radiation they wish to monitor, such as at the beach.

In yet another embodiment, at least the first device 110 may be disposed in an item of clothing, for example; a swim suit or a hat. Disposing the device in an item of clothing may assist with a user taking the first device 110 when outside or in a radiation exposure location. The item of clothing may have a pocket or the like which allows embedding or releasable retainment of the first device 110 in the item of clothing. Alternatively, a clip and/or tether may be attached to an item of clothing and the first device. The tether may be similar to that of a pacifier style tether. A clip for example may be a carabiner clip, a D-clip, a C-clip, a sling loaded clip, a spring hook or the like.

Alternatively, the first device may be integrally formed or disposed in an item of clothing such that it cannot be removed. For example, this may be useful for children's hats, prisoner clothing, swim wear, official uniforms or any other predetermined article of clothing.

The angle of the device may then be factored with respect to input received from a gyroscope, inclinometer, accelerometer, GPS or any other suitable tilt sensor. A tilt UV index may then calculate the actual radiation being received based on a tilt compensated UV index calculation. The UV index calculation may be based on an assumption that the first device 110 has the radiation sensor 130 facing generally upward (relative to the ground). This allows the first device 110 to generate a more accurate reading of radiation exposure for a user of the first device 110. Preferably, the device comprises at least one accelerometer adapted to determine the orientation of the device.

In yet another embodiment, the device may be adapted to detect where a source of radiation is relative to the device. Knowing the orientation of the first device 110 relative to a source of radiation may further allow for the UV index calculation to be further modified compensating for the angle of the radiation source relative to the first device 110.

In yet a further embodiment, an estimation of radiation exposure may be generated by detecting ambient light and a reported real time or periodically updated radiation index, such as a UV index. The device may further comprise an ambient light sensor which may be adapted to continuously detect light in the visible spectrum (visible to a human) or other predetermined electromagnetic waves. Detecting the light may allow the device to alter the estimation of the radiation exposure. For example, lower light levels may indicate that a wearer is in the shade or indoors, rather than outdoors.

Preferably, the server records and stores data related to radiation levels, such as a UV radiation index which may be generated by meteorology stations. Using the detected UV index to generate a UV exposure allows a user to obtain a reading of the radiation exposure when the first device 110 is synchronised with the server, via the second device 110A. The data relating to the location of the user and the UV index may then be matched and can provide another source of estimation for UV exposure of a user.

In yet a further embodiment, the radiation sensor may be a silicon based (Si-based) photodetector. The Si-based photo detector may rely on n-p type semiconductors technology, such as n-p type homojunction semiconductors technology. Other semiconductor technology may also be used, such as titanium dioxide (TiO₂) or zinc oxide (ZnO). Optionally, ZnO nanoparticles on low-cost substrates, such as glass, may be used to detect UV radiation. The radiation sensor 130 may comprise semiconductor particles disposed as beads or dots on the surface which may assist with detection of radiation levels. It will be appreciated that any radiation sensor 130 may be used with the first device 110 of the present disclosure.

Although the disclosure has been described with reference to specific examples, it will be appreciated by those skilled in the art that the disclosure may be embodied in many other forms, in keeping with the broad principles and the spirit of the disclosure described herein.

The present disclosure and the described preferred embodiments specifically include at least one feature that is industrial applicable.

What is claimed is:

1. A system adapted for detecting and recoding UV radiation, the system comprising;
a first device including a first shell encapsulating a power source, a micro-controller, a storage medium, at least one UV sensor and a low power wireless module;
the at least one UV sensor adapted to detect and store UV data; and
wherein the low power wireless protocol is adapted to communicate with at least one second device, the second device including a second shell which is adapted to receive at least a portion of the stored UV data.

2. The system of claim 1, wherein the at least one UV sensor is adapted to detect UVA and UVB radiation.

3. The system of claim 1, wherein the first device further comprises an accelerometer.

4. The system as claimed in claim 1, wherein the first shell further comprises an antenna.

5. The system as claimed in claim 1, wherein the first shell is disposable.

6. The system as claimed in claim 1, wherein the first shell comprises an attachment means such that a user can releasably attach the first shell to an item of clothing.

7. The system as claimed in claim 1, wherein the second shell is adapted to upload at least a portion of the received UV data to a server.

8. The system as claimed in claim 7, wherein the server is a cloud.

9. The system as claimed in claim 1, wherein the second shell comprises a GPS.

10. The system as claimed in claim 9, wherein the second shell is adapted to upload at least one relative location from the GPS of the first shell to the server.

11. The system as claimed in claim 10, wherein the second shell is adapted to associate at least a portion of the received UV data with the relative location.

12. The system as claimed in claim 1, wherein at least one of the first shell and the second shell has a water tight seal.

13. The system as claimed in claim 1, wherein at least one of the first shell and the second shell issues an alert.

14. The system as claimed in claim 1, wherein the UV data stored by the first shell is deleted after the second shell receives the UV data.

15. The system as claimed in claim 1, wherein the UV radiation data is selectively sampled by the first device.

16. The system as claimed in claim 1, wherein the first device further comprises a status indicator.

17. The system as claimed in claim 1, wherein the power source is a non-rechargeable battery.

18. A system adapted for detecting and recoding UV radiation, the system comprising;
a first device including a first shell comprising a power source, a micro-controller, a storage medium, at least one UV sensor and a low power module;
the at least one UV sensor adapted to detect and store UV radiation data; and
wherein the low power protocol is adapted to communicate with a second device, the second device comprising a second shell which is adapted to receive at least a portion of the stored UV data.

19. The system of claim 18, wherein the first device is disposable.

20. The system as claimed in claim 18, wherein the second device logs at least one location and associated location time and the first device associates at least one of the stored UV radiation data with an associated UV radiation data time, such that the associated location time and the associated UV radiation data time can be associatively matched.
